(19) United States
(12) Patent Application Publication
(10) Pub. No.: US 2009/0321535 A1
(43) Pub. Date: Dec. 31, 2009

(54) IRRIGATION SYSTEM

(76) Inventor: Shawn Davis, Yucca Valley, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/147,069

(22) Filed: Jun. 26, 2008

(51) Int. Cl. B05B 12/08

(52) U.S. Cl. 239/63

(57) ABSTRACT

An irrigation system comprises an irrigation zone, a controller, a valve, one or more pipes and at least one ground sensor. The system of pipes is connected to the value, which is operable to read water quantity per unit time. The ground sensors determine water flow and absorption by observing changes in surface temperature. The controller is in communication with the ground sensors and regulates water flow to the irrigation zone based on the readings from the ground sensors. The controller is programmed to deliver a predetermined volume of water and the ground sensor uses an infrared thermometer.

### BACKGROUND

1. Field

This disclosure relates, in general, to irrigation systems.

2. General Background

Irrigation controllers are used in irrigation systems to electrically operate valves that deliver water under pressure to distribution devices for watering vegetation within an irrigation zone. Irrigation systems are usually divided into irrigation zones that have similar watering requirements, thus allowing the amount and frequency of watering to be uniformly regulated for a given area of vegetation.

Once a watering schedule has been set on an irrigation controller, the schedule may need to be changed or adjusted to adapt to seasonal changes, unanticipated soil conditions, topography that results in inadequate or excessive watering in some areas or device malfunctions such as a broken pipe or sprinkler resulting in water running off onto cement.

Typically, irrigation systems are passive; a system will execute a schedule, programmed into a controller, and water an irrigation zone for a preset amount of time regardless of whether the irrigation zone is inadequately or excessively watered. In arid areas, where water is a precious resource, excessive watering or device malfunctions can have a significant cost both monetarily and environmentally.

### SUMMARY

In one embodiment, an irrigation system, in accordance with the present disclosure, comprises an irrigation zone, a valve operable to read water quantity per unit time and one or more pipes connected to the valve, providing water to the irrigation zone. There is at least one ground sensor that takes water flow and water absorption readings within the irrigation zone. The at least one ground sensor determines water flow and water absorption by observing changes in surface temperature within the irrigation zone. There is a controller in communication with the at least one ground sensor that regulates water flow to the irrigation zone based on the readings from the at least one ground sensor. The controller is programmed to deliver a predetermined volume of water.

The controller will deliver the predetermined volume of water uninterrupted to the irrigation zone until the at least one ground sensor determines that excessive water flow or poor absorption has occurred within the irrigation zone.

The controller will stagger the delivery of the predetermined volume of water in response to the at least one ground sensor determining excessive water flow or poor absorption.

A method for irrigating an irrigation zone is disclosed. The method comprises providing a controller with a default irrigation schedule programmed to provide control signals for controlling a plurality of at least one flow-control devices within an irrigation zone and programmed to deliver a predetermined volume of water. An at least one ground sensor is provided in the irrigation zone and is in communication with the controller.

An initial surface temperature reading is taken prior to irrigating the irrigation zone and an at least one subsequent surface temperature reading is taken by the at least one ground sensor within the irrigation zone while irrigating the irrigation zone. The at least one subsequent surface temperature reading to the initial surface temperature reading are compared and the default irrigation schedule is modified in an event that the at least one subsequent surface temperature reading has changed relative to the initial surface temperature reading by a predetermined value.

### DRAWINGS

FIG. 1 is a plan view of an embodiment of an irrigation system in accordance with the present disclosure.

FIG. 2 is a plan view of an embodiment of an irrigation system in accordance with the present disclosure.

FIG. 3 is a process flow diagram of a method for irrigating an irrigation zone in accordance with the present disclosure.

While the specification concludes with claims defining the features of the present disclosure that are regarded as novel, it is believed that the present disclosure's teachings will be better understood from a consideration of the following description in conjunction with the drawing figures, in which like reference numerals are carried forward.

### DETAILED DESCRIPTION

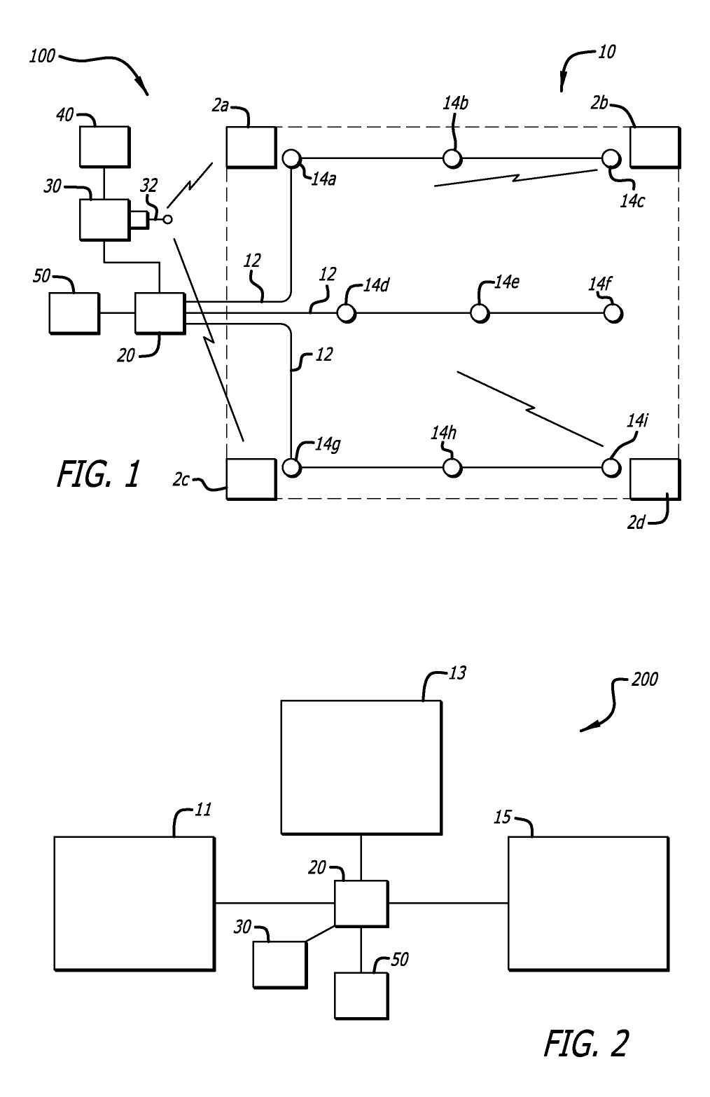

Referring to FIG. 1, there is an irrigation system 100. The irrigation system 100 includes an irrigation zone 10 that is watered or irrigated by water delivery devices 14a through 14i (collectively water delivery devices 14), such as, for example, a plurality of sprinklers. The water delivery devices 14 are connected to one or more pipes 12 through which water is delivered. The one or more pipes 12 are connected to a flow control device or valve 20 that provides water from a water source 50. The valve 20 executes a program and schedule that is programmed into a controller 30 that controls the valve 20 and, thus, water delivery to the irrigation zone 10.

The valve 20 is equipped with a flow meter, or other means known in the art, that can read a quantity of water per unit time, for example, gallons per minute. The valve 20 communicates the quantity of water per unit time to the controller 30 for calculating total gallons consumed. The communication between the valve 20 and the controller 30 can be hardwired or they can communicate wirelessly. The controller 30, thus allows a user to program the irrigation system 100 to use a predetermined volume of water to irrigate or water the irrigation zone 10 as opposed to the timer systems of the prior art.

The irrigation system 100 has at least one ground sensor 2a through 2d (collectively referred to as ground sensors 2) that take water flow and water absorption readings within the irrigation zone 10 in order to determine excessive water flow or poor absorption.

The ground sensors 2 are located in the ground within the irrigation zone 10 and are in wireless communication with the controller 30. The controller 30 includes a transceiver for wireless communication with the ground sensors 2 and will regulate water flow to the irrigation zone 10 based on readings from the ground sensors 2.

The ground sensors 2 determine water flow and water absorption by observing changes in surface temperature within and/or along the perimeter of the irrigation zone 10. The ground sensors 2 use an infrared thermometer to determine the surface temperature. Such an infrared thermometer measures temperature by observing blackbody radiation emitted from an object. Infrared thermometers are sometimes called laser thermometers when a laser is used to help aim the thermometer, or non-contact thermometers that describe their ability to measure the temperature of an object from a distance.

An infrared thermometer generally consists of a lens to focus the infrared energy on to a detector. The detector converts the energy into an electrical signal that can be displayed in units of temperature after being compensated for variations in the ambient temperature.

In one embodiment, the ground sensors 2 are battery powered and located along the perimeter of the irrigation zone 10. The ground sensors 2 monitor the average temperature of a few square feet of cement or concrete surrounding the irrigation zone 10. A drop in temperature of the few square feet of cement or concrete would indicate the presence of a significant amount of water, enough water to lower the average temperature of the surface by a few degrees. A significant amount of water could be present as a result of the soil having poor water absorption or as a result of a broken pipe or sprinkler.

The controller 30 will deliver the programmed volume of water uninterrupted to the irrigation zone 10 until one of the ground sensors 2 determines that excessive water runoff within the irrigation zone 10 is observed. If such an event is observed by one of the ground sensors 2, for example, ground sensor 2a, ground sensor 2a will send a wireless signal to the controller 30. The controller 30 will temporarily discontinue watering. The controller 30 will reinitiate watering at a later time and the ground sensors 2 will continue to monitor the temperature of a few square feet of cement or concrete surrounding the irrigation zone 10.

In one instance, the controller 30 will have a default time where it discontinues watering. Once the default time has expired, watering will resume and the controller 30 will, once again, await notification from the sensors 2 in the event there is poor water absorption. In another instance, the sensors 2 will continue to take temperature reading and will alert the controller 30 in the event that the temperature has risen which would be indicative that the water has dried up or been absorbed into the soil.

The controller 30 will effectively stagger the delivery of the predetermined volume of water in response to one of the ground sensors 2 repeatedly determining excessive water flow or poor absorption within the irrigation zone 10. In this instance, the controller 30 will periodically open and close the valve 20 for the irrigation zone 10.

Furthermore, the controller 30 can notify a user, in response to one of the ground sensors 2 determining excessive water runoff within the irrigation zone 10, to indicate that there might be a problem within the irrigation zone 10. The notification can be sent from the controller 30 to a personal computer 30 as an email, text message or any other alert receivable by a user.

The irrigation system 100 also includes a user interface for programming the watering schedule and the volume of water to deliver to the irrigation zone 10. The user interface could be incorporated with the controller 30. Or the user interface can be a monitor or screen of a personal computer 40 or any other handheld or hardwired device.

In one embodiment, there are a plurality of irrigation zones 11, 13 and 15 in an irrigation system 200. Irrigation zones 11, 13 and 15 are controlled by the controller 20 and operate in the same manner as irrigation zone 10 described above. Typically, the irrigation zones 11, 13, and 15 will be watered separately and defaults programmed into the controller 30 can be set to enable the controller 30 to shut down water delivery to one irrigation zone, in the event excessive water runoff is observed, and move on to watering the next irrigation zone.

The irrigation zones 11, 13 and 15 can be programmed to use a predetermined volume of water that is the same for each zone or they can all be different. For example, irrigation zone 11 could be a cactus garden that only requires 10 gallons of water per week, irrigation zone 13 could be a flower garden that requires 15 gallons of water twice a week and irrigation zone 15 could be the front lawn that requires 25 gallons three times a week.

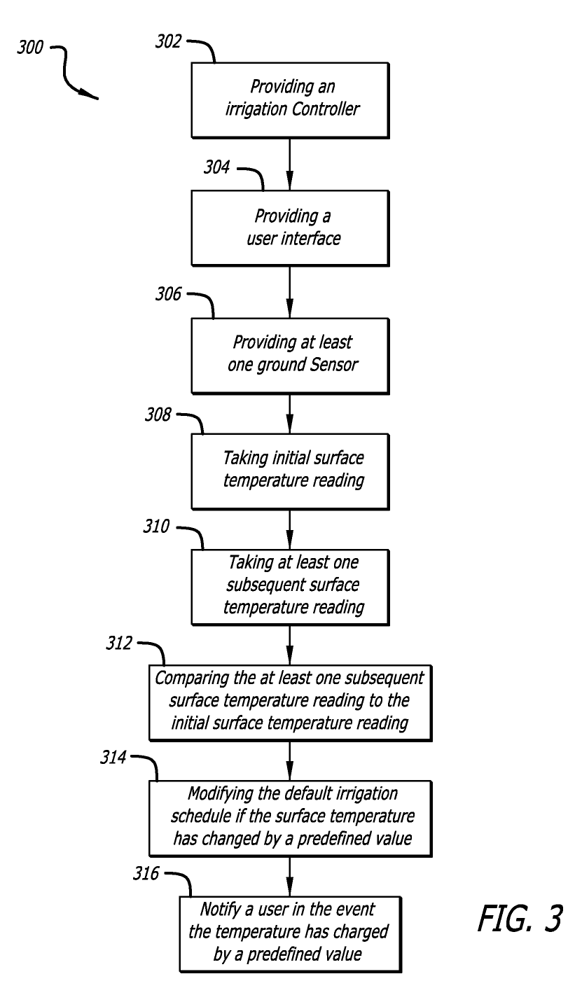

In one embodiment, a method for irrigating an irrigation zone is shown in FIG. 3 as process flow operations 300. In initialization operation 302 and operations 304 and 306, a controller 30, a user interface and at least one ground sensor 2 is provided. The controller 30 that has a default irrigation schedule programmed therein to provide control signals for controlling a plurality of water delivery devices 14 within an irrigation zone. The controller 30 is also programmable by a user to water an irrigation zone with a predetermined volume of water as selected by the user. The user interface is for programming the controller 30 and may be incorporated into the controller 30 or can be a monitor or screen of a personal computer 40 or any other handheld or hardwired device. The at least one ground sensor 2 takes water flow and water absorption readings within an irrigation zone in order to determine if excessive water flow is occurring within the irrigation zone. The at least one ground sensor 2 is located in the ground within an irrigation zone and is in wireless communication with the controller 30. The at least one ground sensor 2 uses an infrared thermometer to determine the surface temperature. Control transfers to operation 308.

In operation 308, the at least one ground sensor 2 takes an initial surface temperature reading within an irrigation zone. The initial surface temperature is taken before an irrigation system, such as irrigation system 100 or 200, has begun to water an irrigation zone. Control transfers to operation 310.

In operation 310, the at least one ground sensor 2 takes at least one subsequent surface temperature reading from the at least one ground sensor 2. The at least one subsequent temperature is taken as an irrigation system is watering its corresponding irrigation zone. Control transfers to operation 312.

In operation 312, the controller 30 compares the at least one subsequent surface temperature reading to the initial surface temperature reading. A drop in temperature of a few square feet of cement or concrete would indicate the presence of a significant amount of water, enough water to lower the average temperature of the surface by a few degrees. Therefore, if the at least one subsequent surface temperature reading has dropped relative to the initial surface temperature reading, it would indicate the presence of a significant amount of water that is at least not being absorbed or the water is being misdirected or there is a malfunction within the irrigation system. Control transfers to operation 314.

In operation 316, the controller 30 modifies the default irrigation schedule in the event that the at least one subsequent surface temperature reading has changed relative to the initial surface temperature reading by a predetermined value. This predetermined level is preferably within 3 to 6 degrees Fahrenheit, but can be any change that is indicative of the presence of water. The temperature range can also vary depending on the climate of the region in which the ground sensor 2 is used.

The controller 30 will deliver the user-programmed volume of water in a single watering to an irrigation zone 10 until one of the ground sensors 2 determines that there is excessive water runoff within the irrigation zone 10. If excessive water runoff is determined, the controller 30 will modify the irrigation schedule by staggering the delivery of the predetermined volume of water. Control transfers to operation 318.

In operation 318, the controller 30 notifies a user in the event that the at least one subsequent surface temperature reading has changed by the predetermined value relative to the initial surface temperature reading.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. An irrigation system comprising:
an irrigation zone;
a valve operable to read water quantity per unit time;
one or more pipes connected to the valve that provide water to the irrigation zone;
at least one ground sensor that takes water flow and water absorption readings within the irrigation zone, wherein the at least one ground sensor determines water absorption by observing changes in surface temperature within the irrigation zone;
a controller in communication with the at least one ground sensor that regulates water flow to the irrigation zone based on the readings from the at least one ground sensor; and
wherein the controller is programmed to deliver a predetermined volume of water.

2. The system of claim 1, wherein the controller delivers the predetermined volume of water uninterrupted to the irrigation zone until the at least one ground sensor determines poor absorption within the irrigation zone.

3. The system of claim 1, wherein the controller will stagger the delivery of the predetermined volume of water in response to the at least one ground sensor determining poor absorption.

4. The system of claim 1, wherein the controller is in wireless communication with the at least one ground sensor.

5. The system of claim 4, wherein the at least one ground sensor utilizes an infrared thermometer to determine a surface temperature within the irrigation zone.

6. The system of claim 1, further comprising a user interface for programming the predetermined volume of water to deliver to the irrigation zone and for notifying a user in response to the at least one ground sensor determining poor absorption within the irrigation zone.

7. The system of claim 6, wherein the controller is in communication with a personal computer.

8. A method for irrigating an irrigation zone, the method comprising:
providing a controller having a default irrigation schedule programmed to provide control signals for controlling at least one flow control device within an irrigation zone and programmed to deliver a predetermined volume of water;
providing an at least one ground sensor in the irrigation zone and in communication with the controller;
taking an initial surface temperature reading from the at least one ground sensor within the irrigation zone prior to irrigating the irrigation zone;
taking at least one subsequent surface temperature reading from the at least one ground sensor while irrigating the irrigation zone;
comparing the at least one subsequent surface temperature reading to the initial surface temperature reading; and
modifying the default irrigation schedule in an event that the at least one subsequent surface temperature reading has changed relative to the initial surface temperature reading by a predetermined value.

9. The method of claim 8, further comprising:
providing a user interface for programming the predetermined volume of water to deliver to the irrigation zone; and
notifying a user in the event that the at least one ground sensor reading the at least one subsequent surface temperature reading has changed by a predetermined value relative to the initial surface temperature reading.

10. The method of claim 8, wherein the step of modifying the default irrigation schedule includes staggering water flow to the irrigation zone until the predetermined quantity of water has been delivered.

11. The method of claim 8, wherein the predetermined volume of water is delivered uninterrupted to the irrigation zone until the at least one subsequent surface temperature reading has changed relative to the initial surface temperature reading by a predetermined value.

12. The method of claim 8, wherein the predetermined value is between 3 and 6 degrees Fahrenheit.

13. The method of claim 10, wherein the predetermined value is between 3 and 6 degrees Fahrenheit.

14. The method of claim 8, wherein the controller is in wireless communication with the at least one ground sensor.

15. The method of claim 14, wherein the at least one ground sensor utilizes an infrared thermometer to determine a surface temperature within the irrigation zone.
